(19) United States
(12) Patent Application Publication
(10) Pub. No.: US 2013/0166421 A1
(43) Pub. Date: Jun. 27, 2013

(54) REAL TIME PROCESSING OF LARGE VOLUME OF VENDOR DATA

(71) Applicants: Agust Kristinn Gudmundsson, Hackettstown, NJ (US); Brian Thomas Hurd, Warwick, NY (US); Adil Soli Belihomji, Kendall Park, NJ (US); Mary Pearl Jelinek, Somerset, NJ (US); Sajid Ahmed, Monmouth Junction, NJ (US); Maria Assunta Sandford, Monroe, NY (US)

(72) Inventors: Agust Kristinn Gudmundsson, Hackettstown, NJ (US); Brian Thomas Hurd, Warwick, NY (US); Adil Soli Belihomji, Kendall Park, NJ (US); Mary Pearl Jelinek, Somerset, NJ (US); Sajid Ahmed, Monmouth Junction, NJ (US); Maria Assunta Sandford, Monroe, NY (US)

(73) Assignee: Cellco Partnership d/b/a Verizon Wireless, Basking Ridge, NJ (US)

(21) Appl. No.: 13/336,656

(22) Filed: Dec. 23, 2011

(51) Int. Cl. G06Q 40/00; G06F 17/30

(52) U.S. Cl. 705/30; 707/769; 707/E17.014

(57) ABSTRACT

Notifications regarding content transactions may be received at a high rate in systems providing content to a large number of customers from a number of vendors. Each notification may contain multiple fields of information about the transaction. Business rules for determining amounts that should be invoiced for content transactions have fields of information for matching to nonfictions. As each notification is received: (1) a rule having fields of information that match fields of information contained within the notification is located; (2) an amount that should be invoiced for the transaction is determined from the located rule; (3) a line item in the determined amount is added to an open invoice for the vendor related to the content transaction that the notification is about; and (4) the updated open invoice may be saved. These steps may all be performed in real time, without copying or redistributing data in the original notification.

### DESCRIPTION OF RELATED ART

In a mobile communication context, a content transaction typically involves signaling communication between a user's mobile device and a content provider system of a vendor. For example, the user may activate a generic client browser or a service specific client application on the mobile device to initiate communications through a network with a server application on the computer system of the vendor. Interaction via the client application, network communication and the server application allow the user to select particular content in a convenient manner; and the server computer or another system of the provider in communication with that computer transmits the selected content through the network to the user's mobile station. Examples of the content that may be involved in such transactions include text, audio, video, and other multimedia materials, as well as application programs that are executable by the mobile station. In many services, the content may be downloaded and stored in the mobile station, for later playback or execution. Other services offer content, particularly audio and video content, in the form of streaming media transmitted at substantially real-time rates for concurrent real-time presentation to the user via the receiving mobile station.

The content itself represents a value to the users. Development and delivery of the content involve investment by the content owner, the content vendor (if a separate entity), and the operator or carrier that provides communications between the content provider system and the mobile station. A number of different business models have been developed between the parties. For example, a user may have a service subscription with the mobile carrier and the carrier bills the subscriber for the content delivered, together with the bill for the network communication or transport service. In such an arrangement, there is typically an agreement between the carrier and the vendor to share the revenue form the content transaction. If the vendor obtains the content for another party, for example via purchase or license, any payment that may be necessary to a separate content owner is paid by the content vendor, e.g. upon receipt of the share of the proceeds from the carrier. Alternatively, agreements between the parties may entail the carrier sharing the money for a particular type of transaction between multiple vendors, for example, between the vendor operating the system that provides the content and the owner (or an intermediary for the owner) of the content.

Even in such a business model, different content transactions result in different charges to the subscriber and different splits of the revenue as between the carrier and one or more vendors. Some transactions may result in reduced charges to the subscriber and attendant splits between the commercial parties involved in the transactions. For example, one party may be sponsoring or subsidizing a particular transaction for promotional purposes. Charges and splits between parties also may differ because different content has different value, etc.

In many cases, one carrier therefore will have arrangements to carry content provided by a number of vendors, and the arrangements with the different vendors vary. The systems of the carrier, however, process data regarding the content transactions to add appropriate charges to the subscribers' bills and to invoice appropriate amounts for payment to the different vendors that are involved in content transactions through the carrier's network.

In a high-volume network serving millions of users' mobile stations over a wide geographic area, there will be millions of content transactions each month, and the data processing systems must process the transaction data to generate the bills and invoices for many such transactions. A carrier's data processing system may need to receive and process at least ten million (10M) content transaction notifications per month from numerous content vendor computer systems. For example, a leading national carrier today may process sixty million (60M) content transaction notifications per month and expects the volume to grow to of 200-400 million records per month or even more, over the coming 3-5 years.

Many departments within a carrier may need access to this content transaction data, such as administration, customer service, marketing, accounting, and billing. Access may also be provided to vendors of the content, as well as others.

The traditional approach for providing such multi-department/party access to such high volume data is for each department/party to replicate the portions of the data that the department/party needs and to process this replicated data via the computer system(s) of the particular department/party. However, this traditional approach can suffer from several drawbacks. For example, replicating data may require synchronization systems to maintain synchronization between the original and all replicated instances of the data, especially when additions or changes are made to the data. Error checking and correcting systems may also be needed to test for and correct errors that can be made during the replication process. The replication, synchronization, and error checking and correcting processes, moreover, typically operate periodically on large batches of data. This can make it very difficult to obtain real time snapshots of the data, such as the amount of money that is currently owed to a particular vendor, the current popularity of particular content, and information needed to quickly respond to customer inquiries. As a result, payments to vendors are often delayed for many weeks, renegotiated vendor contracts may not contain terms that are optimum, and customer support may be impaired.

Systems that manage much smaller volumes of data may not suffer from these problems because the smaller volume system may permit all departments/parties to work off of a single common database, thus eliminating the costs, delays, and complexities of replicated data. However, such a smaller volume system may not be capable of handling the high volume of data that may be present when managing content transactions for a large carrier.

A solution to the costs, complexities, and delays of managing a high volume of content transactions is therefore needed, particularly where real time snapshots are needed.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a network of computer systems, including content provider systems, content vendor systems, a wireless mobile communication device, a desktop computer, and computer systems within a wireless mobile communication carrier that manage content transactions.

FIG. 2 illustrates an example of the vendor data processing system illustrated in FIG. 1.

FIG. 3 illustrates an example of a table of business rules that may be part of the business rules storage system illustrated in FIG. 2.

FIG. 4 illustrates the table of business rules illustrated in FIG. 3, updated with an additional business rule that has the same matching criteria as another business rule in the same table.

FIG. 5 illustrates an example of a table of open invoices that are generated by the vendor data processing system 121 in FIG. 1.

FIG. 6 illustrates an example of a table of line items for the open invoices that are generated by the vendor data processing system illustrated in FIG. 1.

FIG. 7 illustrates another example of the vendor data processing system illustrated in FIG. 1, together with examples of other systems that communicate with it.

FIG. 8 illustrates a process that may be implemented with the vendor data processing system illustrated in FIG. 7.

FIG. 9 illustrates examples of reference databases that are used in connection with the vendor data processing system illustrated in FIG. 7.

FIG. 10 is a simplified functional block diagram of a computer that may be configured as a host or server, for example, to function as some of the computer systems illustrated in FIG. 1.

FIG. 11 is a simplified functional block diagram of a personal computer or other work station or terminal device that may be configured to function as some of the computer systems illustrated in FIG. 1.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

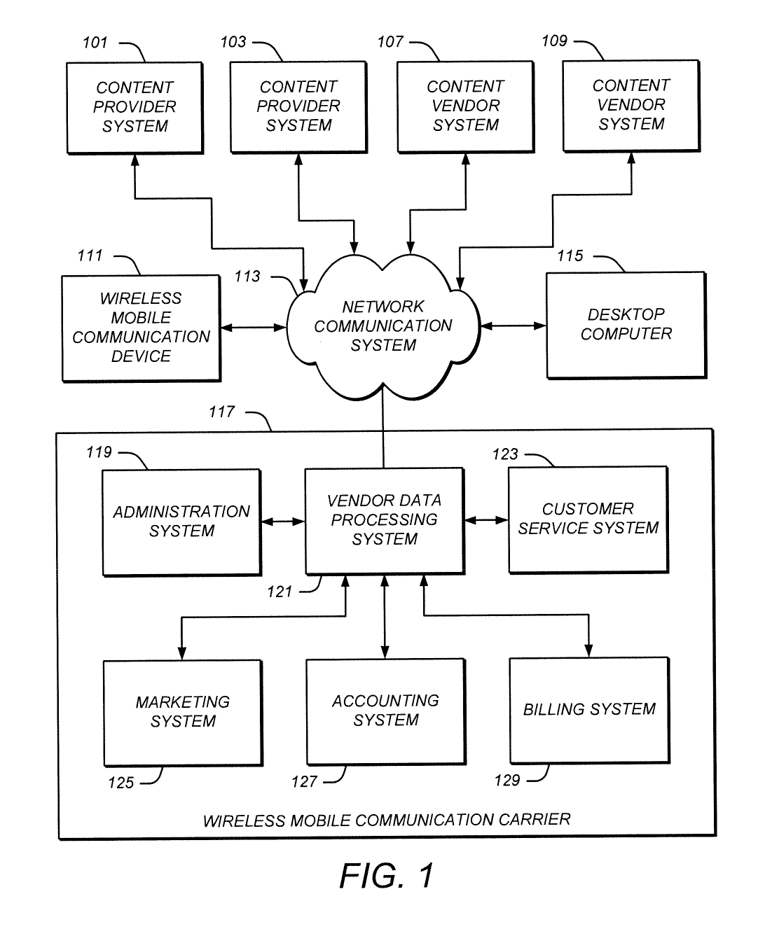

FIG. 1 illustrates a network of computer systems, including content provider systems 101 and 103, content vendor systems 107 and 109, a wireless mobile communication device 111, a desktop computer 115, and computer systems within a wireless mobile communication carrier 117 that manage content transactions.

Various types of computers, such as the wireless mobile communication device 111 and the desktop computer 115, may seek to obtain content from one or more content provider systems, such as the content provider systems 101 and 103, by requesting and receiving the content though a network communication system 113. Although only a single wireless device and a single desktop computer are illustrated in FIG. 1, there may be many more, such as millions.

The network communication system 113 may be of any type. For example, it may consist of or include the Internet, a cellular telephone network, a local area network, a wide area network, or a combination of these.

The content may be of any type. For example, the content may be music, video, images (e.g., wallpaper), votes on TV shows, device or service monitoring software (e.g., heart monitor or fleet management), games, software applications, subscriptions to news services, stock quotes, or web sites. The content may be delivered in the form of one or more files, by streaming, by downloading, by granting access to other systems, and/or in any other way.

The content is provided through the network 113 to users' terminal devices, like the mobile device 111 and the desktop computer 115, by a content provider system, such as one of the content provider systems 101 and 103. Each content provider system may be of any type. For example, a content provider system may be a website or an application store. Each system 101 or 103 may be implemented as one or more computers, which are coupled for communication via the network 113 and are programmed to operate as a server with respect to client programming running on the users' terminal devices.

Any type of user or customer transaction relating to an item of content is deemed a content transaction. For example, a content transaction may be the purchase or licensing of content by a device user or the cancellation of a purchase or licensing transaction.

The content that is the subject of each content transaction may be owned, licensed, or managed by one or more content vendors. The content provider system that provides the content may or may not be owned, operated, and/or managed by the content vendor(s) associated with that content.

As indicated above, content may be acquired by wireless mobile communication devices, such as the wireless mobile communication device 111. Each wireless mobile communication device may have an account with a wireless mobile communication carrier to provide wireless mobile data and/or voice communication services. When the content is acquired by a wireless mobile communication device, the vendor(s) of the content may have an agreement with the wireless mobile communication carrier for the carrier to bill the account of the acquirer for any cost of the content and for the carrier to pay a portion of the proceeds that are billed or collected to the vendor(s) of the acquired content.

To facilitate the billing, accounting and payment processing for content transactions, each content provider system 101 or 103 provides notifications over the network communication system 113 to a vendor data processing system 121 of content transactions that take place using the content provider system 101 or 103. Although only two content provider systems are illustrated in FIG. 1, a larger or smaller number of provider systems may be present.

Each notification of a content transaction that is provided to the vendor data processing system 121 may contain multiple fields of information about the content transaction to which it relates. These fields of information may include, for example, information identifying the content that is the subject of the transaction, the type of the content (e.g., music, video, game, wallpaper), the type of the content transaction (e.g., a purchase or cancellation), the content provider, the vendor(s) of the content (who may be different than the content provider), the customer that is the subject of the content transaction, the date of the transaction, the time of the transaction, the price of the content, discounts, a delivery address (if different from the purchaser's) and/or specifics about the content (such as color, artist, album). While the fields that may be included in different notifications may vary by content and contract, certain fields, such price and content identification, may always be present.

The vendor data processing system 121 is configured to receive and process these notifications, including their fields of information, as more particularly described below.

Various departments may be allowed to communicate with the vendor data processing system 121 to obtain various types of information about these content transactions, such as an administration department, a customer service department, a marketing department, an accounting department, and/or a billing department. These communications may be facilitated, for example, by an administration system 119, a customer service system 123, a marketing system 125, an accounting system 127, and a billing system 129, respectively. As illustrated in FIG. 1, these departments may be part of the wireless mobile communication carrier. Some or all of the exemplary departments may instead be part of a different company and utilize systems of the different company to perform the appropriate data processing.

The vendors of the content may also want to provide and/or receive information to the wireless mobile communication carrier 117 relating to the content transactions, such as aggregated invoices for the content acquisitions by customers of the carrier. The vendors may also wish to check the records of the carrier to determine the payments these records indicate the carrier is to make to the vendors for content transactions. To facilitate this, each vendor may communicate with the vendor data processing system 121 through the network communication system 113 using a content vendor system, such as a content vendor system 107 or 109.

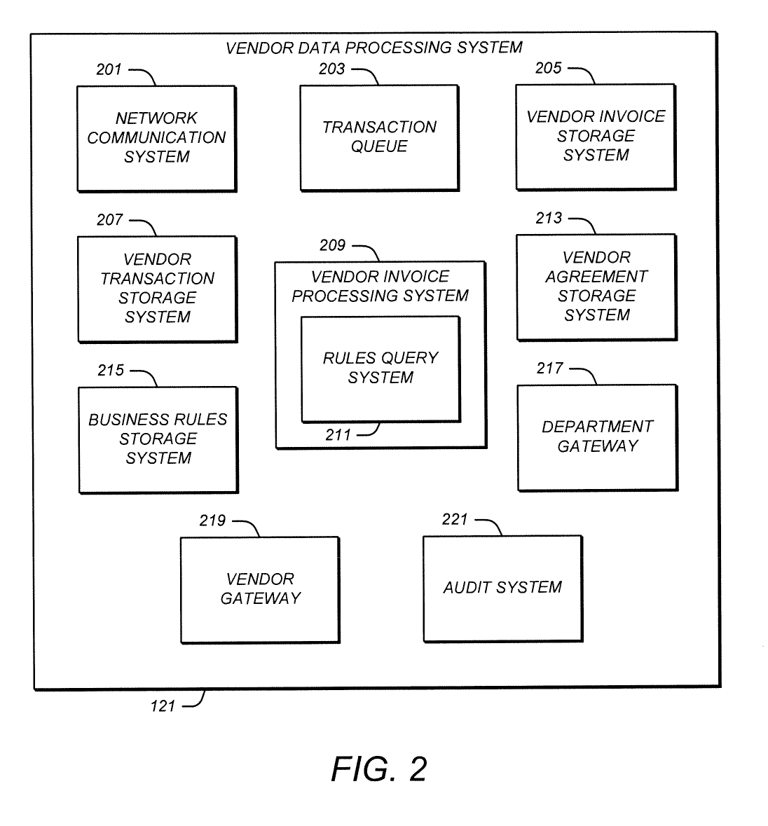

FIG. 2 illustrates an example of the vendor data processing system 121 illustrated in FIG. 1. As illustrated in FIG. 2, the vendor data processing system 121 includes a network communication system 201, a transaction queue 203, a vendor invoice storage system 205, a vendor transaction storage system 207, a vendor invoice processing system 209 containing a rules query system 211, a vendor agreement storage system 213, a business rules storage system 215, a department gateway 217, a vendor gateway 219, and an audit system 221.

The network communication system 201 is configured to communicate with the network communication system 113. The network communication system 201 may include a network interface card and/or any other type of network communication device.

The network communication system 201 is configured to continuously receive notifications of content transactions from the computer network at a high monthly rate, such as at a rate of at least ten, fifty, one hundred, two hundred, or five hundred million notifications per month. In certain cases, the rate of notifications may be sufficiently high such that only a mainframe computer (or number of individual computers acting in parallel such that the processing power provided is at least equivalent to a mainframe computer) may be able to process the notifications in real time. Each notification comes from one of the content provider systems such as 101 or 103 and contains multiple fields of information about a content transaction relating to a vendor, a customer and content, as described above. Notifications may in addition or instead come from content vendor systems, such as the content vendor system 107 or 109, and/or from elsewhere. There may be a separate notification for each content transaction provided at or about the time of the transaction. Notifications may in addition or instead come in batches, with each batch being in a single file.

The vendor transaction storage system 207 is configured to store the notifications as records within the system 207, as the notifications are received in real time. The concept of “real time,” as used herein, means at least substantially contemporaneously with the event to which it is in reference. This includes any short delay that may be occasioned by information being temporarily stored in a queue. When notifications are obtained in batches in a batch file, the concept of “real time” embraces the short delays that may be needed to process these batch files.

The vendor transaction storage system 207 may be configured to prohibit any notification information that has been received and stored from being subsequently modified, even when a portion of that information has been determined to be erroneous. Still, changes to this information may be stored, but in a way that fully preserves the original information. A transaction tracking system may be used for this purpose.

The vendor transaction storage system 207 may be of any type. For example, vendor transaction storage system 207 may consist of or include one or more hard disk drives, CD and/or DVD drives, RAMs, flash memories, or any combination of these. These hardware devices may be at a single location or distributed across multiple locations.

Each content transaction may be assigned a unique transaction ID by the vendor transaction storage system 207. All details about each content transaction may then be obtained from the transaction notification record stored in the system 207 by other systems, such as by the administration system 119, by the customer service system 123, by the marketing system 125, by the accounting system 127, and by the billing system 129, merely by referencing the unique transaction ID of the content transaction. These other systems may rely upon the unique transaction ID as a reference or pointer to obtain all needed information about a transaction from the record in the storage system 207, without ever replicating any of that needed information.

The business rules storage system 215 is configured to store business rules. Each business rule specifies a rule for determining an amount that should be invoiced for content transactions having fields of information that match fields of information associated with the rule. The business rules storage system 215 may be of any type, such as any of the types discussed above in connection with the vendor transaction storage system 207. Each rule may be assigned a unique rule ID by the business rules storage system 215.

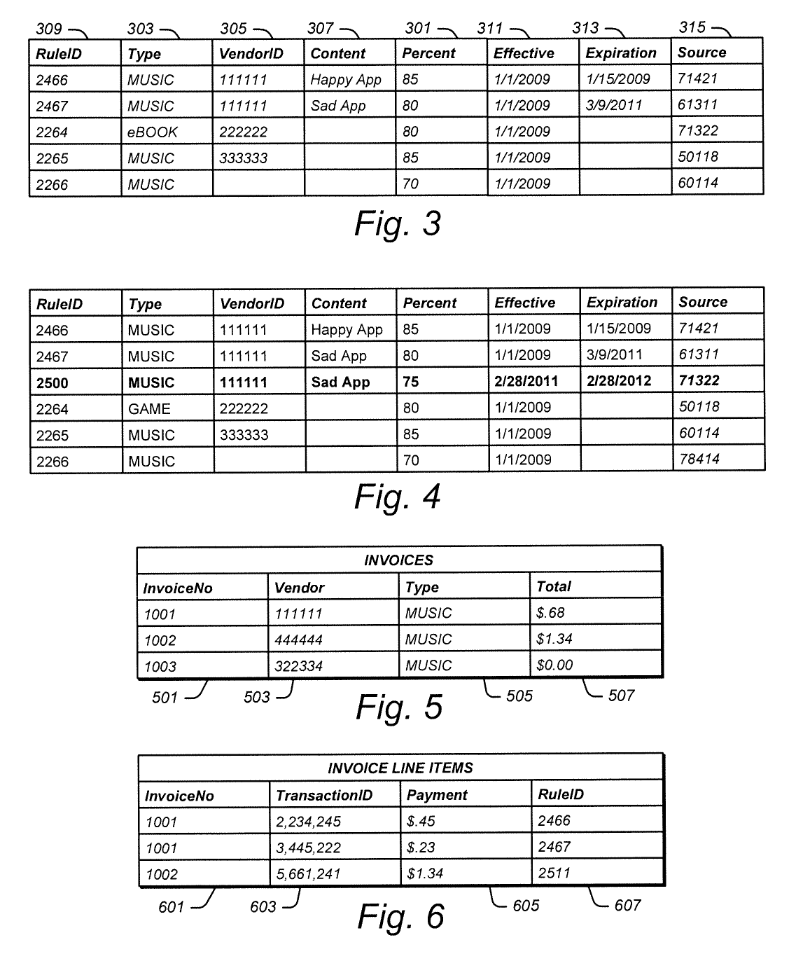

FIG. 3 illustrates a simple example of a table of business rules that may be part of the business rules storage system 215 illustrated in FIG. 2. As illustrated in FIG. 3, each rule may contain various fields of information relating to the rule. One field in each rule may contain information that is relevant to determining an amount that should be paid to the vendor associated with the content transaction to which the rule applies. This amount may be specified in any way, such as by a percentage of the purchase price, as indicated by a Percentage field 301 in the example of FIG. 3.

In some cases, a single content transaction may require more than a single vendor or other party to be paid a share of the purchase price. In such a case, the rule may specify the identities of all of the vendors that are to be paid and information relevant to determining how much to give to each vendor.

As also illustrated in FIG. 3, each business rule is associated with other information relating to the rule. In the example, the additional information associated with the rule includes a RuleID field 309 that provides a unique ID for each rule; a VendorID field 305 that identifies the vendor, a Type field 303 that identifies the type of content, a Content field 307 that identifies the specific content, an Effective date field 311 that specifies an effective date for the rule; an Expiration date field 313 that specifies an expiration date for the rule; and a Source field 315 that identifies information that was used to determine the rule.

Each rule may contain additional fields and/or not all of the fields that are illustrated. For example, there may be a status field that indicates whether a rule is active. A rule may not be active, for example, because it has been replaced by another rule or has not yet been approved.

Some types of content may have different sets of fields than others. In such a case, a different table of rules may be provided for each different type of content that has a different set of fields.

The information that is used to determine a rule may be an agreement with a vendor. These agreements may be stored in text or image format in the vendor agreement storage system 213 and may be identified by the same code as that in the source field of the business rule. The vendor agreement storage system 213 may be of any type, such as any of the types discussed above in connection with the vendor transaction storage system 207.

The transaction queue 203 is configured to temporarily store notifications received by the network communication system 201 until they can be processed by the vendor invoice processing system 209. This queue may be a temporary memory device, such as one or more RAMs. The queue may include safety features to insure against losses in the event of a crash or power failure.

The rules query system 211 is configured to locate a rule in the business rules storage system 215 having fields of information that match corresponding fields of information contained within each notification. The rules query system 211 is configured to perform this operation in real time as each notification is received by the network communication system. The transaction queue 203 permits small delays to be tolerated, but has a finite size. Thus, the rules query system 211 must be able to perform this operation at a speed fast enough to ensure that the transaction queue 203 does not overflow, even when batches of content transaction notifications are received in a batch file.

The rules query system 211 may utilize any approach for identifying a matching rule in the business rules storage system 215. For example, the rules query system 211 may be configured, in response to each notification, to locate the rule in the business rules storage system 215 that matches certain fields of information in the notification, such as the Type field 303, the VendorID field 305, and the Content field 307.

As illustrated in FIG. 3, some of the fields in a particular business rule may contain a blank value. A blank value is considered to be a generic value that matches any value in the corresponding field of the content transaction notification. The blank may be a null or an empty string. Values other than a blank could instead be used for such a generic value, such as unique code that will never be present in the corresponding field in any notification.

When a generic value is used in a rule, that rule may match a group of notifications, and that group of notifications may include one or more notifications that also match another rule. For example, both RuleIDs 2265 and 2266 will match any notification that is of the MUSIC type and concerns VendorID 33333.

When there are multiple matching rules, the rules query system 211 may be configured to select the rule that has the largest number of non-generic matching fields, with no mismatched fields of information. This algorithm enables a small number of rules to cover a large number of combinations, thus increasing the speed of the search for a matching rule, while insuring that every deviation from a generic rule can be programmed and enforced.

For example, a company may have the general policy of paying 70 percent of the proceeds from each content transaction to its vendor for all MUSIC type content. This general policy is reflected by RuleID 2266. However, it may enter into an agreement with vendor 22222 to pay 80 percent of these proceeds, which is reflected by RuleID 2264. It may also enter into an agreement with vendor 111111 to pay 80% of the proceeds for Sad App content, but 85% of the proceeds for Happy App content. This is reflected in RuleIDs 2467 and 2466, respectively. The search algorithm described above will nevertheless result in selection of the correct rule for each content transaction.

The rules query system 211 may be configured in any way to implement this algorithm. For example, the rules query system 211 may be configured to first search for a rule that matches fields of information about a content transaction with specific values, ignoring generic value matches. If a match is found, the matching rule is used. If a match is not found, the rules query system 211 may be configured to re-query the business rules storage system 215, but to allow a match to a generic value in a first predetermined field, such as in the Content field 307. If a match is still not found, the rules query system 211 may be configured to re-query the business rules storage system 215 with the same query, but to allow a match to a generic value in both the first predetermined field and in a second predetermined field, such as the VendorID field 305 and the Content field 307, respectively. If a match is still not found, the rules query system 211 may be configured to re-query the business rules storage system 215 with a query that matches to a generic value in all of the matching fields (i.e., a default rule is used if present). If a match is still not found, an error may be signaled. In an alternate configuration, the failure to find a matching rule may not result in an error, but rather may be construed by the rules query system 211 to mean that no charge should be made for the content transaction.

Generic values in an increasing number of fields may be searched until ultimately searching for a default rule that applies to all sets of search criteria in the absence of specific value for any of them in the rules. In other configurations, some fields may not be permitted to contain any generic values. Some systems may limit the number of search iterations that can take place.

Instead of performing multiple queries, the rules query system 211 may be configured to implement the matching algorithm with only a single query that is more sophisticated. For example, the query may search for a match in one or more fields to either a specific value or to the generic value. The following query is an example, with a null being the generic value:

Type=MUSIC and (VendorID=22222 or VendorID=Null) and (Content=ZebraSongs or Content=Null)

However, such a query can result in multiple matches: one match to a rule containing the more specific value in a field, and other matches to rules containing a generic value in one or more fields. For example, the query above would match and therefore return RuleIDs 2264 and 2266.

The query may therefore also include sorting criteria that gives preference to matches to specific values over matches to generic values. Thus, if both a generic and specific match to a particular field is found, the specific match will be provided first.

The following is the example of the query given above, with such a sorting criteria added:

Type=MUSIC and (VendorID=22222 or VendorID=Null) and (Content=ZebraSongs or Content=Null) order by Content, VendorID

The query may also include filter criteria that filters the results so as to only deliver the first match in a sorted set. This will result in the faithful adherence to the algorithm recited above, namely to match to the rule that has the largest number of non-generic matching fields, with no mismatched fields of information.

The following is the example of the query given above, with such a filtering criteria added:

Type=MUSIC and (VendorID=22222 or VendorID=Null) and (Content=ZebraSongs or Content=Null) order by Content, VendorID and ROW_NUM<2

The rules query system 211 may or may not be configured to consider the Effective date field 311 in the query. An example of how this might work is now presented.

A Status flag may be used to exclude specific rules. In one embodiment, to maintain integrity of the system if a rule is found to be in error, the rule is never deleted, only marked as invalid so that the rule will not be applied to a transaction notification. The notification processing indicates the rule selected for each transaction, which allows an auditor to see exactly what rule was used and make corrections accordingly or justify corrections made later. The Status flag may also be used to edit and accept rules during configuration.

FIG. 4 illustrates the table of business rules illustrated in FIG. 3, updated with an additional business rule (RuleID 2500) that has the same Type, VendorID, and Content specific values as another business rule in the same table (RuleID 2467). However, the new rule (RuleID 2500) has a later effective date than the earlier rule (RuleID 2467).

The new rule (RuleID 2500) may have been entered as a result of an amended agreement with vendor 111111 that provides only 75% of the payment, rather than the 80% previously provided by the original agreement, as reflected in the earlier rule (RuleID 2467). In the case where there are multiple rules with the same number of non-generic matching fields, the rules query system 211 may be configured to select the rule with the later effective date. Such a search algorithm may enable a rule to be updated without having to delete or even modify any other version with an earlier effective date.

The rules query system 211 may or may not be configured to take into consideration a rule that has an effective date that is after the date of the content transaction. When a later effective date is taken into consideration, the rules query system 211 may be configured to ignore any rule with an effective date that is after the date of the content transaction.

The rules query system 211 may or may not take into consideration the Expiration date in the Expiration date field 313. When taken into consideration, the rules query system 211 may be configured to ignore rules with an expiration date that is before the date of the content transaction.

The date of a content transaction may be specified in any way, such as in one of the fields of information that are part of its notification or by being equated with the date on which the notification is received.

As outlined by the discussion of FIGS. 3 and 4, the rules query system 211 will search a business rule table or database in storage system 215 to select one of the rules to apply to the content transaction, for reach received notification. Returning to FIG. 2, the vendor invoice processing system 209 may be configured to determine an amount that should be invoiced for each transaction based on the rule that is located by the rules query system 211. Each invoice may indicate payment that must be made to a vendor or payment that must be made by a vendor. In connection with the rules illustrated in FIG. 3, for example, this determination may be made by multiplying the percentage in the Percentage field 301 by the amount of the transaction, as specified in a field of information that may be part of the notification or that may be obtained elsewhere, such as from a database that contains content pricing information. Again, this may be done in real time as each notification is received by the network communication system, with the only delay being attributed to delay caused by batch delivery and/or temporary queuing in the transaction queue 203.

The vendor invoice processing system 209 is also configured to add a line item in the determined amount to an open invoice for the vendor that is related to the content transaction that each processed notification is about. Again, this may be performed in real time as each notification is received by the network communication system, with the only delay being attributed to delay caused by batch delivery and/or temporary queuing in the transaction queue 203.

To facilitate this functionality, the vendor invoice processing system 209 may be configured to see if there already is an open invoice for the vendor by looking in the vendor invoice storage system 205. If there is an open invoice for the identified vendor, the vendor invoice processing system 209 may be configured to add the line item to this open invoice. If there is not, the vendor invoice processing system 209 may be configured to open a new invoice for the vendor and then add the line item to it. The vendor invoice processing system 209 is configured to then save the updated open invoice in the invoice storage system 205. Again, this may be done in real time as each notification is received by the network communication system, with the only delay being attributed to delay caused by batch delivery and/or temporary queuing in the transaction queue 203.

FIG. 5 illustrates an example of a table of open invoices that are generated by the vendor data processing system 121 in FIG. 1. As illustrated in FIG. 5, each open invoice may have an InvoiceNo field 501, a Vendor field 503, a content Type field 505, and a Total amount field 507 in this table.

FIG. 6 illustrates an example of a table of line items for one or more of the open invoices that are generated by the vendor data processing system 121 in FIG. 1. As illustrated in FIG. 6, each line item entry in a vendor invoice contains multiple fields of information. For example, the line item includes an InvoiceNo field 601 referencing the invoice in the table in FIG. 5 to which it belongs. The line item also includes a Payment field 605 that specifies the amount that should be invoiced as dictated by the vendor invoice processing system 209 based on the rule that was located by the rules query system 211 and the cost of the content transaction. Each line item also includes a RuleID field 607 that points to the matching rule in the business rules storage system 215 that was located by the rules query system 211. Each line item also includes a TransactionID field 603 that points to the record of the content transaction stored in the vendor transaction storage system 207 that was the subject of the notification that resulted in the addition of the line item. Each line item may contain additional fields and/or may not have all of these fields.

In the event that a single content transaction triggers payment to multiple vendors, a separate line item in the table illustrated in FIG. 6 may be generated by the vendor invoice processing system 209 for each of the vendors. The different line items would include different invoice numbers in field 601 so as to be included in the respective invoices for the different vendors. However, each of the multiple line items would include the same transaction ID in field 603, to point to the record of the content transaction stored in the vendor transaction storage system 207.

Returning again to FIG. 2, the vendor invoice processing system 209 may be configured to perform the operations that are described above in response to the receipt of each notification by the network communication system 201. In the event that the transaction queue 203 is used, this may be delayed until such time as each notification reaches the top of the transaction queue 203 for processing by the vendor invoice processing system 209.

The audit system 221 is configured to audit information that is stored in the vendor invoice storage system 205, the vendor transaction storage system 207, the vendor agreement storage system 213, and/or the business rules storage system 215. In connection with open invoices in the vendor invoice storage system 205, the audit system 221 may be configured to allow a user to trace any line item to the rule on which the line item is based by linking to that rule using the information in the RuleID field 607 in the line item (see, e.g., FIG. 6). The audit system 221 may also be configured to allow a user to trace back to the information that was used to create the linked rule, such as to a contract with the involved vendor, by linking to that information using the information in the Source field 315 for the rule in the rule table (see e.g. FIGS. 3 and 4). Similarly, the audit system 221 may be configured to allow a user to trace back to the information contained within the notification that resulted in the line item by linking to that information using the information in the TransactionID field 603 in the line item (see e.g. FIG. 6).

The department gateway 217 is configured to allow various departments of the wireless mobile communication carrier to access, supplement, and/or modify information within the vendor data processing system 121. An administration department may use the administration system 119, a customer service department may use a customer service system 123, a marketing department may use the marketing system 125, an accounting department may use the accounting system 127, and/or a billing department may use the billing system 129. The department gateway 217 allows each department to view open invoices in the vendor invoice storage system 205, to follow the links provided in each line item of an open invoice (e.g. to the notification via the transaction ID in field 603), and to follow the link(s) provided in the Source field 315 of each linked rule. The department gateway 217 may also be configured to allow a user to execute custom or pre-formulated queries that seek information from the vendor invoice storage system 205, the vendor transaction storage system 207, the vendor agreement storage system 213, and/or the business rules storage system 215. The department gateway 217 may also be configured to allow a user to formulate and execute “what-if” queries that seek to determine results—such as vendor payment obligations—if one of the parameters used to calculate these results—such as the percentage that must be paid to a vendor—is changed.

In some cases, a department may be connected to the same network system as the vendor invoice processing system 209 and thus may be able to communicate directly with it, without the need for the department gateway 217.

The vendor gateway 219 may be configured to allow the various vendors that are associated with content transactions to similarly seek information that is relevant to their involvement with these transactions. For example, the vendor gateway 219 may be configured to allow a vendor to see any open invoice that has been generated for it, as contained within the vendor agreement storage system 213. In the example of FIGS. 1 and 2, a first vendor operates a content vendor system 107 to access information in the vendor invoice processing system 209 via the vendor gateway 219, and another vendor operates a content vendor system 109 to access information in the vendor invoice processing system 209 via the vendor gateway 219.

In some cases, a content vendor system 107 or 109 may be connected to the same network system as the vendor invoice processing system 209 and thus may be able to communicate directly with it, without the need for the vendor gateway 219.

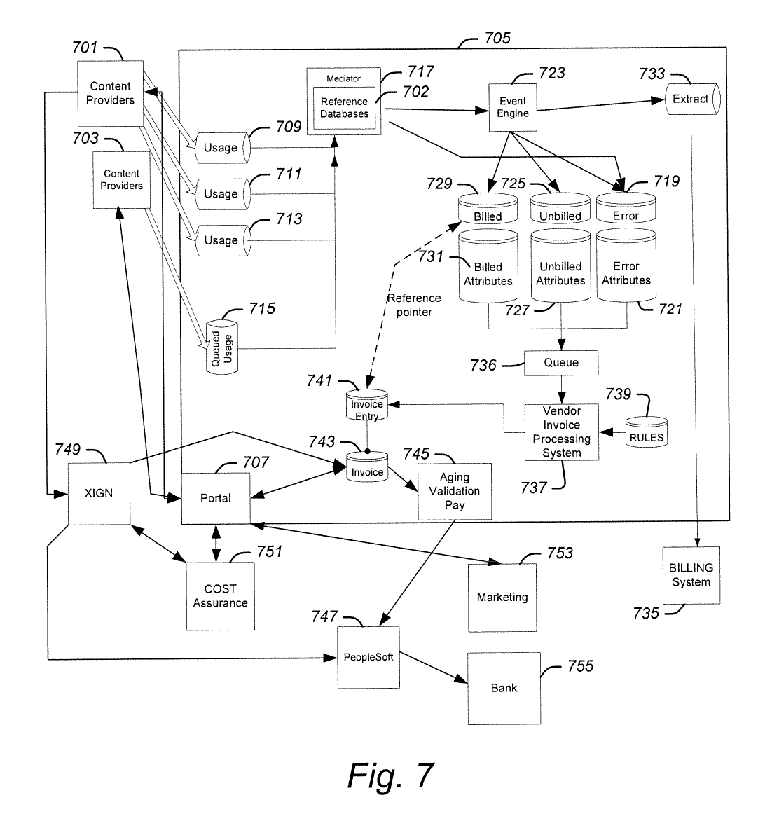

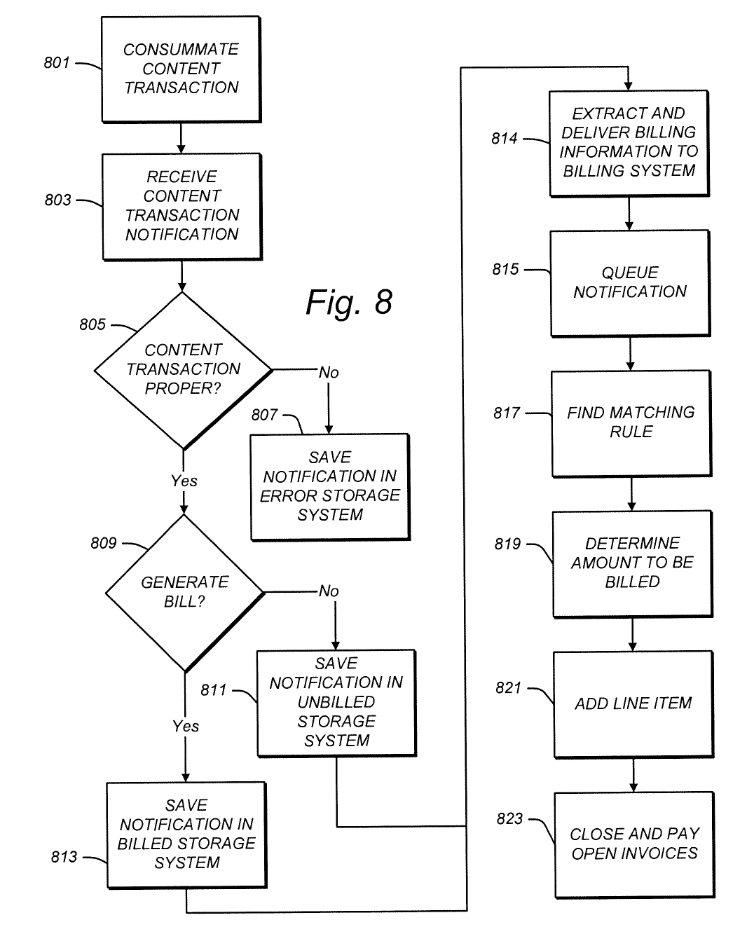

FIG. 7 illustrates another example of the vendor data processing system illustrated in FIG. 1, together with examples of other systems that communicate with the vendor data processing system. FIG. 8 illustrates a process that may be implemented with the vendor data processing system illustrated in FIG. 7. The vendor data processing system illustrated in FIG. 7 may implement processes other than the one illustrated in FIG. 8, and the process illustrated in FIG. 8 may be performed by a vendor data processing system different from the one illustrated in FIG. 7.

Content providers, such as content providers 701 and 703, may consummate a content transaction of any of the types described above, as reflected by a Consummate Content Transaction step 801. A notification concerning each such content transaction may be received by a vendor data processing system 705, as reflected by a Receive Content Transaction Notification step 803. Transaction notifications may arrive from the content providers (701, 703) in the form of batch files for bulk delivery of transaction notifications, as represented by the files 709, 711 and 713; or transaction notifications may arrive from the content providers (701, 703) individually as generated by the provider systems upon occurrences of transactions (as from a web site). Individually arriving transaction notifications may be queued up individually at 715 for processing immediately.

The notifications from the batch usage files and/or from the queue are delivered to a mediator 717 for processing. The mediator 717 is configured to perform a series of mediation functions to determine from the respective notification whether each content transaction is proper, as reflected in a Content Transaction Proper? decision step 805. To facilitate this decision at 805, the mediator 717 makes reference to various reference databases 702.

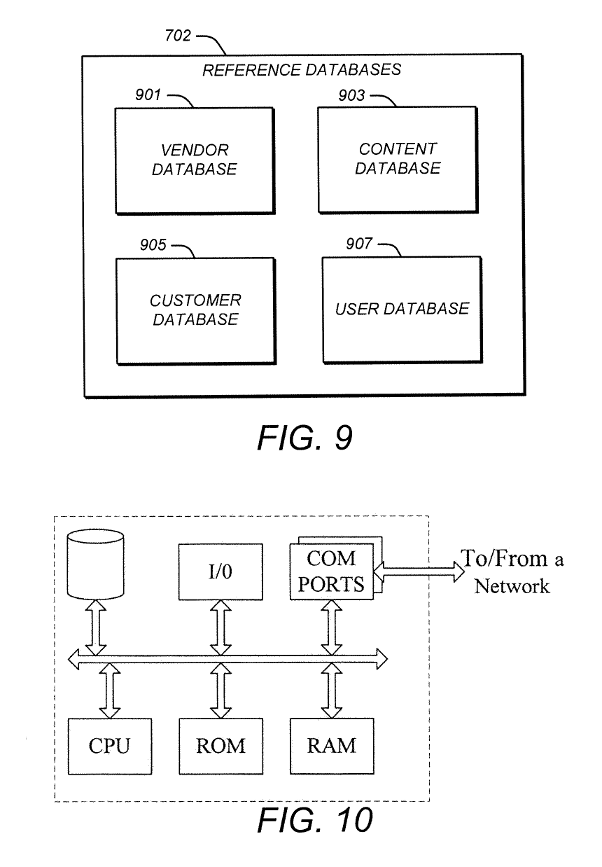

FIG. 9 illustrates examples of reference databases that are used in connection with the vendor data processing system 705 illustrated in FIG. 7. As illustrated in FIG. 9, one of the reference databases is a vendor database 901. This database contains information identifying vendors under contract, thus allowing the mediator 717 to verify that a content transaction has been with an authorized vendor. The vendor database 901 may also contain contracts between the vendor and the wireless mobile communication carrier.

The reference databases also include a content database 903. This database is consulted by the mediator 717, for example, for the purpose of determining whether content that is the subject of a content transaction has been approved. Such approval may be provided by the mobile communication carrier and may be indicative of the carrier's decision to bill and collect its users for this item or type of content. It may also contain pricing information relating to the content.

The reference databases also include a customer database 905 that is used by the mediator 717 for the purpose of determining whether a customer that participated in a content transaction is a current customer, e.g., a current customer of a mobile communication carrier that has agreed to have the carrier bill the customer and collect from the customer for the content delivered to the customer's device(s).

The reference databases also include a user database 907 that is used by the vendor data processing system 705 to authenticate users that seek access to the vendor data processing system 705, e.g. from various departments of the carrier and/or from the various vendors.

If any notification is not approved by the mediation process that is implemented by the mediator 717, such as, for example, a notification not being with an approved vendor or current customer, the mediator 717 causes the notification to be delivered into an error storage system 719, together with attributes of the error(s) in an error attributes storage system 721, as reflected in a Save Notification In Error Storage System step 807. The attributes, for example, may be indicative of the nature of the errors, such as the identification(s) of the disapproved vendor and/or the disapproved customer that caused the error.

On the other hand, content transactions that are approved by the mediator 717 are passed by the mediator 717 to an event engine 723. The event engine 723 is configured to determine whether the content transaction is one for which a bill should be generated, as reflected by a Generate Bill? Decision step 809. The event engine 723 does so by consulting the content database 903 and/or by analyzing information that may be part of the notification about the content transaction.

If the content transaction is not billable, the event engine 723 may direct the notification about it to an unbilled storage system 725, as reflected in a Save Notification In Unbilled Storage System step 811, along with attributes about the unbillable transaction to an unbilled attribute storage system 727. Such attributes about the unbillable transaction, for example, may be content type, vendor, description, price, color, size, artist, label, length, pixels or other characteristics of the content, some of which may or may not pertain to the bill or a later settlement.

On the other hand, if the content transaction is a billable transaction, the event engine 723 directs the notification to a billed storage system 729, as reflected in a Save Notification In Billed Storage System step 813, together with attributes about the billable transaction to a billed attributes storage system 731. The attributes may be similar to the attributes discussed above in connection with the step 811. The event engine 723 is also configured to extract billing information 733 from each billable notification and deliver it to a billing system 735, as reflected in an Extract and Deliver Billing Information to Billing System step 814. The billing system 735 is configured to generate bills to customers for the content transactions.

Whether billed or not, the notification is delivered to a queue 736 until a downstream vendor invoice processing system 737 is able to process the notification, as reflected by a Queue Notification step 815. The queue 736 and the vendor invoice processing system 737 perform the same functions as the transaction queue 203 and the vendor invoice processing system 209 discussed above, respectively. For example, the vendor invoice processing system 737 consults a rules database 739, which is comparable to the business rules storage system 215 described above, to identify a rule having fields of information that match corresponding fields of information contained within the notification, as reflected by a Find Matching Rule step 817. The applicable rule may be found at 817 using any of the matching approaches discussed above. The vendor invoice processing system 737 then determines an amount that should be invoiced with respect to one or more vendors for the transaction based on the located rule, as reflected by a Determine Amount To Be Billed step 819. The vendor invoice processing system then adds a line item to an invoice entry table 741 relating to an invoice in an invoice table 743 (or opens an invoice in the invoice table 743 if needed) for each vendor related to the content transaction, as reflected in an Add Line Item step 821.

An aging validation pay system 745 is configured to close each invoice periodically and cause it to be delivered to a PeopleSoft™ accounting system 747 that pays the invoice by electronically transferring the needed funds to a bank 755, as reflected by a Close and Pay All Open Invoices step 823.

Each closed invoice may be compared by the PeopleSoft™ accounting system 747 to invoices that are generated by the content providers using the XIGN™ accounting system 749. Notification of any differences may be given.

A portal 707 serves functions similar to the gateways in the example of FIG. 2, to allow personnel/systems of various carrier departments and/or of the vendors to access data in the system 705.

A cost assurance department 751 may have access to all of the information stored in the invoice entry table 741, the invoice table 743, the billed storage system 729, the billed attributes storage system 731, the unbilled storage system 725, the unbilled attributes 727, the error storage system 719, and the error attributes storage system 721, as well as to the invoices from content providers that are provided by the XIGN™ accounting system 749. The cost assurance department may calculate tax withholding and/or make needed adjustments to the invoices before they are paid. Office of Foreign Assets Control (OFAC) and/or tax compliance steps may also be taken. A marketing system 753 may similarly provide users in a marketing department with access to all of the databases in the vendor data processing system 705.

Each of the databases may be stored in any type of storage system, such as any of the types discussed above in connection with the vendor transaction storage system 207.

A system such as 121 (FIG. 1) or 705 (FIG. 1) may be implemented on a relatively small scale computer system rather than on a mainframe computer, for example, to avoid replication of the notifications because of the technique described above that radically reduces the number of rules that need to be searched to locate the correct rule for each notification. Notwithstanding, the system is capable handling a high rate or volume of notifications per month, for example, tens of millions, hundreds of millions, or more per month. The processing technique outlined above may also offer an advantage over a solution that relies on replication, in that the system can also handle the notification processing and make updated invoices and related data available in substantially real time as transactions are consummated and notifications are provided to the system.

As shown by the above discussion, functions relating to the various vendor provider and carrier systems, including those of the vendor data processing system, may be implemented on computers operating as the various elements shown in FIG. 1 or in FIG. 7. Although special purpose devices may be used, such systems also may be implemented using one or more hardware platforms intended to represent a general class of data processing device to run programming so as to implement the respective functions discussed above.

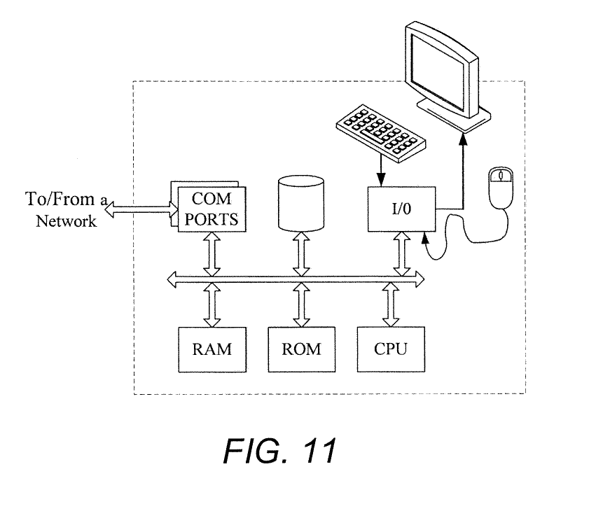

FIGS. 10 and 11 provide functional block diagram illustrations of general purpose computer hardware platforms. FIG. 10 illustrates a network or host computer platform which may be used to implement a server that may function as the content provider system 101 or 103, the content vendor system 107 or 109, the administration system 119, the vendor data processing system 121, the customer service system 123, the marketing system 125, the accounting system 127, and/or the billing system 129 illustrated in FIG. 1. FIG. 11 depicts a computer with user interface elements which may be used to implement a personal computer or other type of work station or terminal device, that may function as the wireless mobile communication device 111 and/or the desktop computer 115 illustrated in FIG. 1. The computer of FIG. 11 may also act as a server, if appropriately programmed. The structure, programming and general operation of such computer equipment are well known; and, as a result, the drawings should be self-explanatory.

A server, for example, includes a data communication interface for packet data communication. The server also includes a central processing unit (CPU), in the form of one or more processors, for executing program instructions. The server platform typically includes an internal communication bus and program storage and data storage for various data files to be processed and/or communicated by the server, although the server may receive programming and data via network communications. The hardware elements, operating systems, and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 11). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Each computer may include software (e.g., one or more operating systems, device drivers, application programs, and/or communication programs). When software is included, the software includes programming instructions and may include associated data and libraries. When included, the programming instructions are configured to implement one or more algorithms that implement one more of the functions of the computer system, as recited herein. Each function that is performed by an algorithm also constitutes a description of the algorithm. The software may be stored on one or more non-transitory, tangible storage devices, such as one or more hard disk drives, CDs, DVDs, and/or flash memories. The software may be in source code and/or object code format. Associated data may be stored in any type of volatile and/or non-volatile memory.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. A data processing system comprising:
a network communication system configured to continuously receive notifications from a computer network at a high monthly rate, each notification containing multiple fields of information about a content transaction relating to a vendor;
a transaction storage system configured to store each of the notifications as they are received in real time, along with a unique identifier for each notification;
a rules storage system configured to store business rules, each specifying a rule for determining an amount that should be invoiced for content transactions based on notifications having fields of information that match fields of information associated with the rule;
an invoice storage system configured to store open invoices, each for a vendor of content; and
an invoice processing system having access to the transaction storage system configured to in real time as each notification is received by the network communication system:
locate a rule in the rules storage system having fields of information that match fields of information contained within the notification;
determine an amount that should be invoiced for the transaction based on the located rule;
add a line item in the determined amount to an open invoice for the vendor related to the content transaction that the notification is about; and
save the updated open invoice in the invoice storage system.

2. The data processing system of claim 1 wherein the invoice processing system is configured to make reference to each notification in the transaction storage system by its unique identifier without fully replicating the fields of information about the content transaction data that is the subject of the notification.

3. The data processing system of claim 1 wherein the invoice processing system is configured to make data for each invoice available in near real time.

4. The data processing system of claim 1 wherein:
the rules storage system contains a plurality of the business rules;
at least one field of information for at least one of the business rules has a generic value that matches any value in the corresponding field contained within a notification; and
the invoice processing system is configured in connection with each notification to locate the rule in the rules storage system that matches the largest number of fields of information contained within the notification, excluding matches to any generic values, and with no mismatched fields of information.

5. The data processing system of claim 4 wherein the invoice processing system is configured to locate the rule using only a single query.

6. The data processing system of claim 5 wherein the single query seeks rules that match a specific value or, if unable to match to the specific value, the generic value.

7. The data processing system of claim 4 wherein the single query includes an instruction to sort the results, giving preference to matches to specific values over matches to generic values.

8. The data processing system of claim 7 wherein the single query includes an instruction to filter the results so as to only deliver the first match in a sorted set.

9. The data processing system of claim 1 wherein the invoice processing system is configured to include a link in each added line item to the located rule, in the rules storage system, on which the added line item is based.

10. The data processing system of claim 1 wherein the rules storage system is configured to store a link along with each rule to information that was used to determine the rule.

11. The data processing system of claim 10 wherein the information is a vendor contract on which the rule is based.

12. The data processing system of claim 1 wherein the invoice processing system is configured to include in each added line item the unique identifier of the notification that is associated with the line item, as a link to the notification associated with the line item in the transaction storage system.

13. The data processing system of claim 1 wherein the invoice processing system is configured to locate the rule, determine the amount, add the line item, and save the updated invoice in response to the receipt of each notification.

14. The data processing system of claim 1 further comprising a transaction queue configured to temporarily store the notifications received by the network communication system until they can be processed by the invoice processing system.

15. The data processing system of claim 1 further comprising a vendor gateway configured to provide vendors with real time access to their respective open invoices.

16. The data processing system of claim 1 further comprising a department gateway configured to provide business departments associated with the data processing system with real time access to the open invoices and the notifications.

17. The data processing system of claim 1 wherein the rules storage system is configured to store an effective date for each rule and wherein the invoice processing system is configured to ignore any rule that has an effective date that has not yet arrived when locating a matching rule.

18. The data processing system of claim 17 wherein the invoice processing system is configured to locate the matching rule that has the latest effective date that has already past when more than one rule matches the fields of information contained within a notification.

19. The data processing system of claim 1 wherein the network communication system, the transaction storage system, and the invoice processing system are configured to perform the functions that are recited in this claim in connection with notifications at the rate of at least fifty million per month.

20. The data processing system of claim 1 wherein the rules storage system is configured to store the rules in tables and wherein each table is representative of transactions relating to a different type of content.

21. The data processing system of claim 1 wherein each rule specifies a percentage of payment that is to be made.

22. The data processing system of claim 1 wherein at least one rule specifies an amount that should be invoiced to at least two different parties.

23. A data processing system comprising:
a rules storage system containing a plurality of rules, each specifying a rule that is to be applied to a circumstance that matches multiple fields of information, at least one of the fields of information having a generic value, that matches any value;
a rules query system configured to:
receive multiple fields of information relating to a circumstance; and
query the rules storage system for the rule that matches the largest number of the fields of information relating to the circumstance, excluding matches to any generic values, and with no mismatched fields of information.

24. A data processing system comprising:
a rules storage system containing a plurality of rules, each specifying a rule that is to be applied to a circumstance that is described with fields of information that match fields of information associated with the rule;
a data storage system;
a rules query system configured to:
receive fields of information that describe a circumstance;
query the rules storage system for a rule in the rules storage system that matches the received fields of information; and
a data processing system configured to:
apply the matching rule to the circumstance; and
cause the results of application of the matching rule to the circumstance to be stored in the data storage system, along with information that identifies the matching rule that was applied.
